(19) United States
(12) Patent Application Publication
(10) Pub. No.: US 2004/0209675 A1
(43) Pub. Date: Oct. 21, 2004

(54) Gaming machine

(76) Inventor: Nobuo Yaegashi, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/697,040

(22) Filed: Oct. 31, 2003

(30) Foreign Application Priority Data
Nov. 18, 2002 (JP) 2002-334119

(51) Int. Cl. G06F 19/00

(52) U.S. Cl. 463/25

(57) ABSTRACT

A gaming machine includes a medal insertion slot 22 having an opening 101 for a player to insert a medal so that the player inserts a medal through the opening 101 for playing a game. The medal insertion slot 22 includes: a medal guide projection 102 projecting in the forward direction of the gaming machine for guiding a medal to the opening 101; and a medal guide projection 102 being made asymmetrical. Accordingly, when the player inserts medals into the medal insertion slot, failure of inserting medal as the thumb or the forefinger of the player or the medal, etc., hits with the projection part can be lessened and the player can easily insert medals into the medal insertion slot.

### BACKGROUND OF THE INVENTION

1. Field of the Invention

The present invention relates to a gaming machine for the player to insert a medal into a medal insertion slot for playing a game.

2. Description of the Related Art

A conventional pinball slot machine (a so-called “Pachi-Slot machine” in Japan) in a related art includes a coin insertion slot 7 (medal insertion slot) with a groove 7a (opening) having the length direction formed in a lateral direction parallel with the machine front, as shown in FIG. 4 in JP-A-2000-167108. In most of such pinball slot machines in related arts, medal insertion slot 7 is provided on the front right of the machine and most players insert medals into the opening 7a of the medal insertion slot 7 with the right hand. The player inserts a medal into the medal insertion slot with the thumb and the forefinger.

The coin insertion slot 7 of the pinball slot machine in the related art will be discussed in more detail. The coin insertion slot 7 is implemented as a medal guide projection projecting in the forward direction of the pinball slot machine 1 for guiding a medal to the opening and the medal guide projection includes an inner peripheral part configured to be in contact with the outer peripheral surface of a coin and a pair of projection parts placed away from each other and projecting on the top of the inner peripheral part, as shown in FIGS. 3 and 4 in JP-A-2000-167108.

The above structure is disclosed in JP-A-2000-167108.

### SUMMARY OF THE INVENTION

However, in the medal insertion slot of the pinball slot machine in the related art, there is a problem that when the player inserts medals into the opening of the medal insertion slot with the right hand holding the medals, as the thumb or the forefinger of the player or the medal hits with the projection part, the player fails in inserting the held medals and drops the medals to the floor.

It is therefore an object of the invention to provide a gaming machine for making it possible to lessen failure of medal insertion as the thumb or the forefinger of a player or a medal and the like hits with a projection part when the player inserts medals into an opening of medal insertion slot, and enabling the player to easily insert medals into the opening.

According to the invention, there is provided a gaming machine (for example, 1) including: a medal insertion slot (for example, 22) having an opening (for example, 101) for a player to insert a medal for playing a game, wherein the medal insertion slot is includes a medal guide projection (for example, 102) projecting in the forward direction of the gaming machine for guiding a medal to the opening, wherein the medal guide projection includes: an inner peripheral part (for example, 104) configured to be in contact with the outer peripheral surface of the medal; and a pair of projection parts (for example, 110R and 10L) placed away from each other and projecting on the tops of both ends of the inner peripheral part, and wherein an angle (for example, γ) between a ridgeline (for example, 105R) of one of the projection parts and a horizontal line (for example, H) is configured to be different from an angle (for example, β) between a ridgeline (for example, 105L) of the other projection part and a horizontal line (for example, H). According to the configuration, when the player inserts a plurality of medals held with the right hand into the opening, failure of medal insertion as the thumb or the forefinger of the player or the medal hits with the projection part 110R can be lessened and the player can easily insert medals into the opening.

In the invention, the angle (for example, γ) between the ridgeline (for example, 105R) of one projection part and the horizontal line (for example, H) may be larger than the angle (for example, β) between the ridgeline (for example, 105L) of the other projection part and the horizontal line (for example, H). According to the configuration, when the player inserts a plurality of medals held with the right hand into the opening, failure of medal insertion as the thumb or the forefinger of the player or the medal hits with the projection part 110R can be lessened and the player can easily insert medals into the opening.

In the invention, a height (for example, hR) of the start point of the ridgeline (for example, 105R) of one projection part on the side of the opening may be the same as a height (for example, hL) of the start point of the ridgeline (for example, 105L) of the other projection part on the side of the opening. According to the configuration, when the player inserts a plurality of medals held with the right hand into the opening, retaining of the medals in the forward width direction can be solidified on the side of the opening.

In the invention, the gaming machine may include a frontward projection portion (for example 10) for fixing the medal insertion slot (for example, 22), wherein an angle (for example, α) between the upper face of the frontward projection portion and the horizontal line (for example H) may be substantially equal to the angle (for example, β) between the ridgeline (for example, 105L) of the other projection part and the horizontal line (for example H). According to the configuration, when the player abuts a plurality of medals held with the right hand against the inner peripheral part and guides the medals into the opening, the plurality of medals can be reliably guided into the opening in the inner peripheral part placed away from the side of the opening.

In the invention, an angle (for example, θR) between a line connecting a top (for example, 200R) of one projection part and a bottom (for example, 201R) and the horizontal line may be smaller than an angle (for example, θL) between a line connecting atop (for example, 200L) of the other projection part and a bottom (for example, 201L) and the horizontal line. According to the configuration, the player can easily insert a plurality of medals held with the right hand into the nip between the paired projection parts along the side of one projection part.

### BRIEF DESCRIPTION OF THE DRAWINGS

In the accompanying drawings:

FIG. 1 is a drawing to show an embodiment of a gaming machine according to the invention and is a perspective view to show the appearance of a pinball slot machine as gaming machine;

FIG. 2 is a perspective view to show the appearance of the pinball slot machine with reels displayed in the embodiment of the invention;

FIG. 3 is a drawing to show the configuration of a liquid crystal display in the embodiment of the invention;

FIG. 4 is a perspective view of medal insertion slot in the embodiment of the invention;

FIG. 5 is a front view of the medal insertion slot in the embodiment of the invention;

FIG. 6 is a sectional view taken on line VI-VI in FIG. 7;

FIG. 7 is a side view of the medal insertion slot in the embodiment of the invention;

FIG. 8 is a sectional view taken on line VIII-VIII in FIG. 7;

FIG. 9 is a drawing to show symbol rows drawn on the outer peripheral surfaces of the reels in the embodiment of the invention;

FIG. 10 is a drawing to show prizes and numbers of payout medals corresponding to winning symbol combinations in the embodiment of the invention;

FIG. 11 is a block diagram to show the configuration of a main control circuit in the embodiment of the invention;

FIG. 12 is a drawing to show a winning stop control table used when internal winning of small prize is accepted in the embodiment of the invention;

FIG. 13 is a drawing to show a forward push, center push losing stop control table used when internal winning of small prize is accepted in the embodiment of the invention;

FIG. 14 is a drawing to show a reverse push losing stop control table used when internal winning of small prize is accepted in the embodiment of the invention; and

FIG. 15 is a block diagram to show the configuration of a sub-control circuit in the embodiment of the invention.

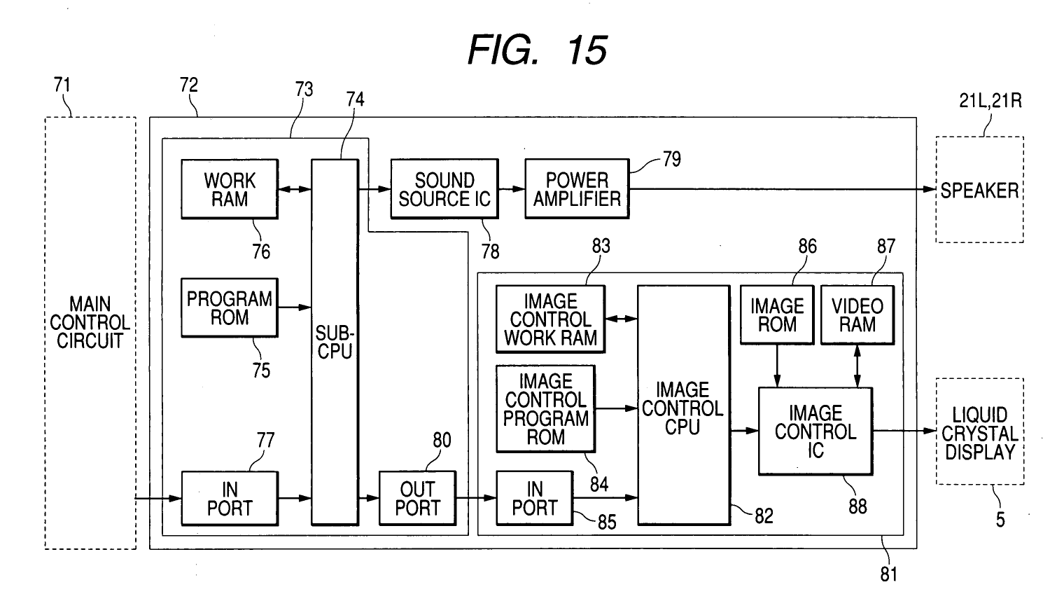

### DETAILED DESCRIPTION OF THE PREFERRED EMBODIMENTS

Referring now to the accompanying drawings, there is shown a preferred embodiment of the invention.

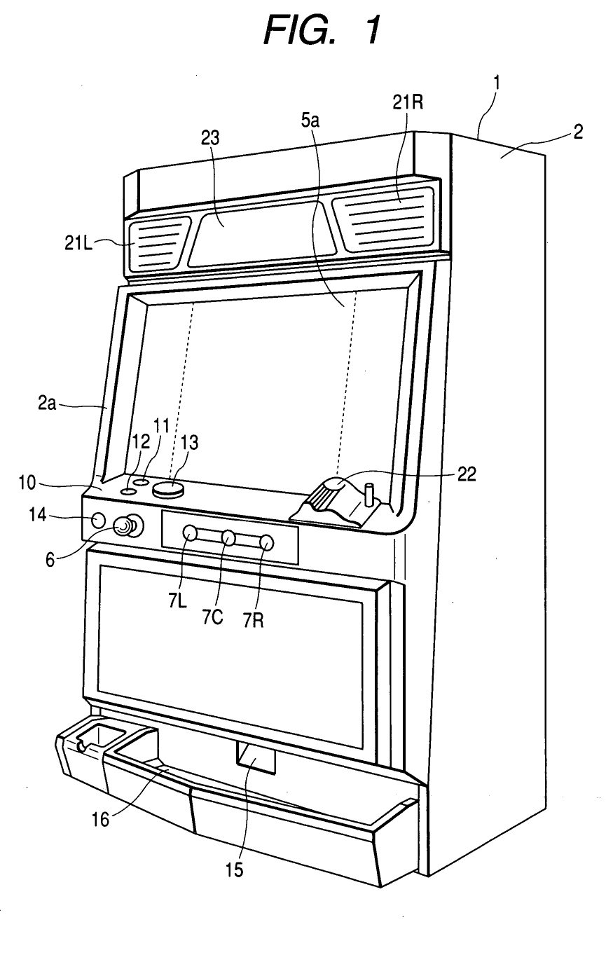

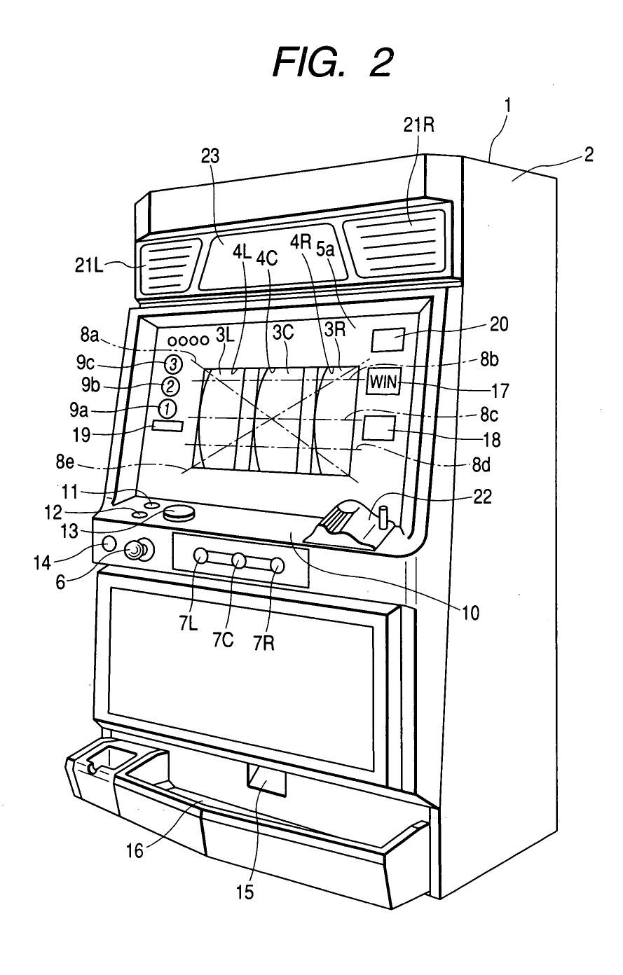

FIG. 1 shows an embodiment applying a gaming machine according to the invention to a pinball slot machine (a so-called “Pachi-Slot machine” in Japan). FIG. 2 shows a state that a full screen display is not displayed by a liquid crystal display in display screen 5a and a member such as reels 3 disposed at the back of the liquid crystal are displayed through the display screen 5a.

To begin with, the configuration will be discussed. In FIG. 1, a pinball slot machine 1 as a gaming machine is provided for the player to play a game using game medium such as coins, medals and tokens. In the description that follows, it is assumed that the player uses medals.

A panel display unit 2a substantially as a vertical plane is formed at the front of a cabinet 2 forming the whole of the pinball slot machine 1, and a liquid crystal display 5 having a rectangular 15-inch liquid crystal display screen 5a is provided in front of the panel display unit 2a. An image can be displayed on the substantially full face of the display screen 5a. BET lamps 9a, 9b, and 9c, a WIN lamp 17, a payout display unit 18, a credit display unit 19, and a bonus game information display unit 20 are displayed under the control of a main control circuit 71 outside the liquid crystal display area.

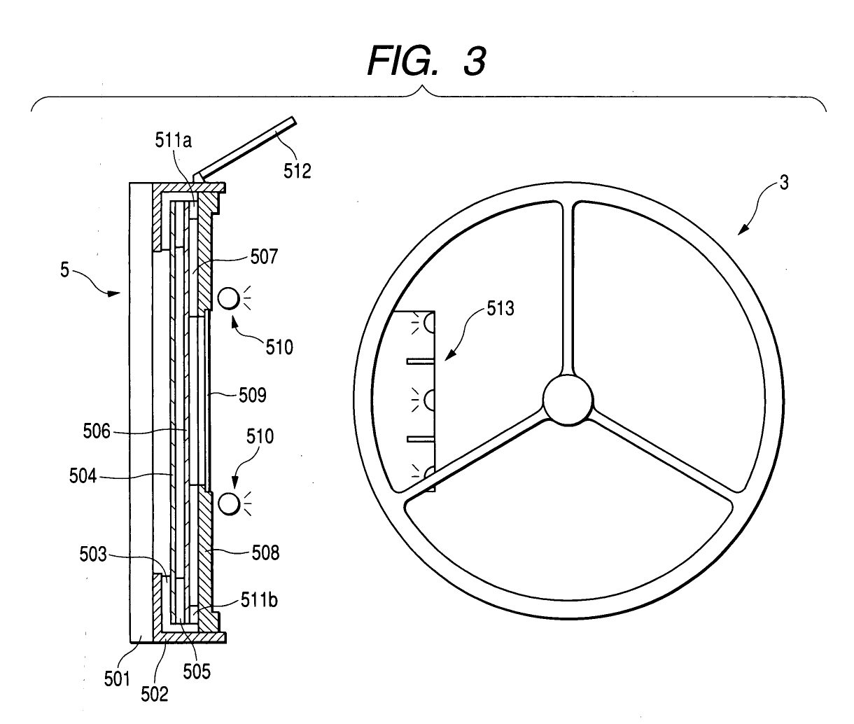

The configuration of the liquid crystal display 5 is as shown in FIG. 3. In FIG. 3, a transparent acrylic plate 501 is provided in front of the liquid crystal display 5, followed by a reel glass base 502, a bezel metal frame 503, liquid crystal 504, a liquid crystal holder 505, a diffuser sheet 506, a light guide plate 507, a rear holder 508, and an antistatic sheet 509 which are stacked in order. The light guide plate 507 is a plate material subjected to special treatment (containing laser beam machining) to uniformly reflect light on the back of a plate member such as acrylic plate. The light guide plate 507 receives light of cold-cathode tube 511a, 511b as light source from the end face, reflecting the light on the rear, and producing uniform surface light emission. The light guide plate 507 and the rear holder 508 are formed with vertically oriented rectangular display windows (4L, 4C, and 4R in FIG. 2). The display windows 4L, 4C, and 4R are visually observed through the liquid crystal display 5. The display driver 512 is disposed in the upper part of the liquid crystal display 5 for displaying the liquid crystal 5. The antistatic sheet 509 prevents dusts from being deposited on the portion touching the reel window (display window). A fluorescent tube 510 is used as a backlight for the display windows. The display windows 4L, 4C, and 4R receive light from the fluorescent tube 510, reflected light produced as the light from the fluorescent tube 510 is reflected on the surfaces of the reels 3, and light of reel backlights 513 provided for the reels 3. The light enables the player to recognize the liquid crystal 504. The reel backlights 513 each having three longitudinally placed LEDs are provided in a one-to-one correspondence with the reels 3 for illuminating the symbols on the reels 3 from the backs of the reels 3.

The display windows 4L, 4C, and 4R are formed with a top line 8b, a center line 8c, and a bottom line 8d in the horizontal direction and a cross down line 8a and cross up line 8e in the slanting directions as pay lines. As the pay lines, one, three, or five lines are made activated as the player operates a 1-BET switch 11, a 2-BET switch 12, or a MAX-BET switch 13 (described later) or inserts medals into medal insertion slot 22. Which pay lines are made activated is indicated as a BET lamp 9a, 9b, or 9c (described below) is lighted.

In the cabinet 2b, three reels (left reel 3L, center reel 3C, and right reel 3R) each with a symbol row including different types of symbols placed on the outer peripheral surface are provided in a row for rotation, and are contained in symbol row display means. The player can observe the symbols on the reels through the display windows 4L, 4C, and 4R. Each reel rotates at a constant speed (for example, 80 revolutions per minute).

The 1-BET lamp 9a, the 2-BET lamp 9b, the MAX-BET lamp 9c, and a credit display unit 19 are provided on the left of the display windows 4L, 4C, and 4R. The 1-BET lamp 9a, the 2-BET lamp 9b, or the MAX-BET lamp 9c is lighted in response to the number of medals bet to play one game, which will be hereinafter referred to as the BET count.

In the embodiment, one game is over when all reels stop. When the BET count is 1 and one pay line is made activated, the 1-BET lamp 9a is lighted; when the BET count is 2 and three pay lines are made activated, the 2-BET lamp 9b is lighted; and when the BET count is 3 and all the five pay lines are made activated, the MAX-BET lamp 9c is lighted. The credit display unit 19 includes seven-segment LEDs for displaying the deposited number of medals.

The WIN lamp 17 and the payout display unit 18 are provided on the right of the display windows 4L, 4C, and 4R. The WIN lamp 17 is lighted when the winning game of BB or RB is complete. The WIN lamp 17 is lighted at a predetermined probability when the internal winning is accepted as BB or RB. The payout display unit 18 includes seven-segment LEDs for displaying the number of medals paid out when the winning game is complete.

The bonus game information display unit 20 is provided in the upper right corner of the display screen 5a of the panel display unit 2a. The bonus game information display unit 20 includes seven-segment LEDs for displaying the number of RB games that can be played, the possible number of winning games of RB (described later).

A frontward projection portion 10 of a substantially horizontal line is formed below the display screen 5a. The display screen 5a displays not only the various lamps and the various display units, but also various effects of animation and the “operation order” required for realizing completion of the winning game when the internal winning of “small prize of bell” is accepted in the “assistance time period” described in the related Art

The medal insertion slot 22 is provided at the right end of the frontward projection portion 10, and the 1-BET switch 11, the 2-BET switch 12, and the MAX-BET switch 13 are provided at the left end of the frontward projection portion 10. The 1-BET switch 11 enables the player to bet one of the credited medals by one push operation on a game. The 2-BET switch 12 enables the player to bet two of the credited medals by one push operation on a game. The MAX-BET switch 13 enables the player to bet as many medals as the maximum number of medals that can be bet on a game by one push operation. As the player operates any of the BET switches, the corresponding pay lines are made activated as described above.

A C/P switch 14 for the player to switch between credit and payout of the medals obtained by playing games by pushbutton operation is provided on the left of the front of the frontward projection portion 10. As the C/P switch 14 is switched, medals are paid out from a medal payout opening 15 in a lower part of the front and are stored in a medal reception tray 16.

On the right of the C/P switch 14, a start lever 6 (contained in start operation means) for rotating the reels for starting variably display the symbols in the display windows 4L, 4C, and 4R (starting a game) as the player operates the start lever 6 is attached so that it can be turned in a predetermined angle range.

The speakers 21L and 21R are provided on the upper left and right of the cabinet 2, and a payout table panel 23 for displaying winning symbol combination, and the number of payout medals is provided between the two speakers 21L and 21R.

Three stop buttons (left stop button 7L, center stop button 7C, and right stop button 7R) as operation buttons contained in stop operation means for stopping rotation of the three reels 3L, 3C, and 3R are provided at the center of the front of the frontward projection portion 10 and below the display screen 5a.

Here, in the embodiment, the stop operation performed by the player pushing the first stop button when all reels rotate is called “first stop operation,” the stop operation next performed by the player pushing the second stop button is called “second stop operation,” and the stop operation performed by the player pushing the third stop button following the second stop operation is called “third stop operation.”

Since the pinball slot machine of the embodiment is provided with the three stop buttons 7L, 7C, and 7R, there are six different operation orders of the stop buttons. Then, the operation orders are distinguished from each other as follows: The left stop button 7L is abbreviated to “left,” the center stop button 7C to “center,” and the right stop button 7R to “right.”

To indicate the operation order, the abbreviations of the stop buttons 7L, 7C, and 7R are listed from left to right in the stop operation order. For example, when the player operates the left stop button 7L as the first stop operation, the center stop button 7C as the second stop operation, and the right stop button 7R as the third stop operation, the operation order is indicated as “left center right.” In the embodiment, the six different operation orders of “left center right,” “left right center,” “center left right,” “center right left,” “right left center,” and “right center left” are available.

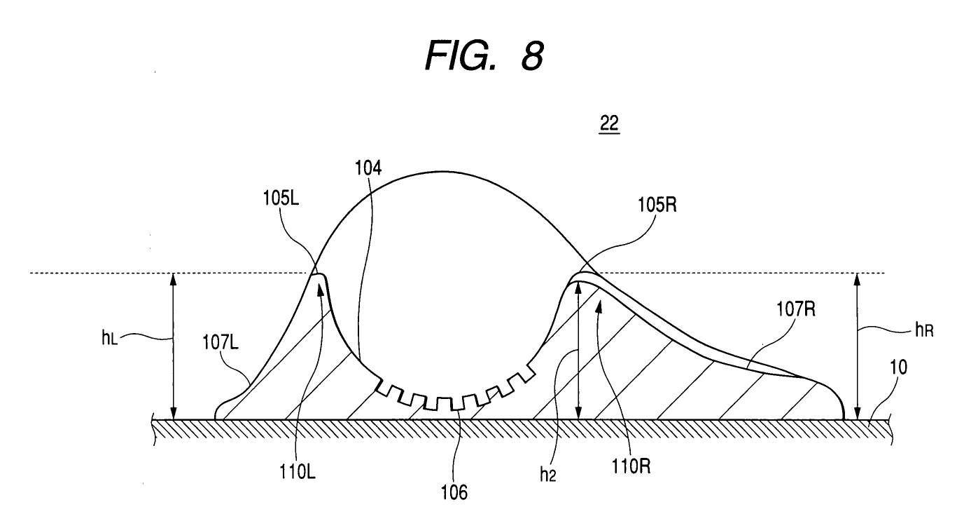

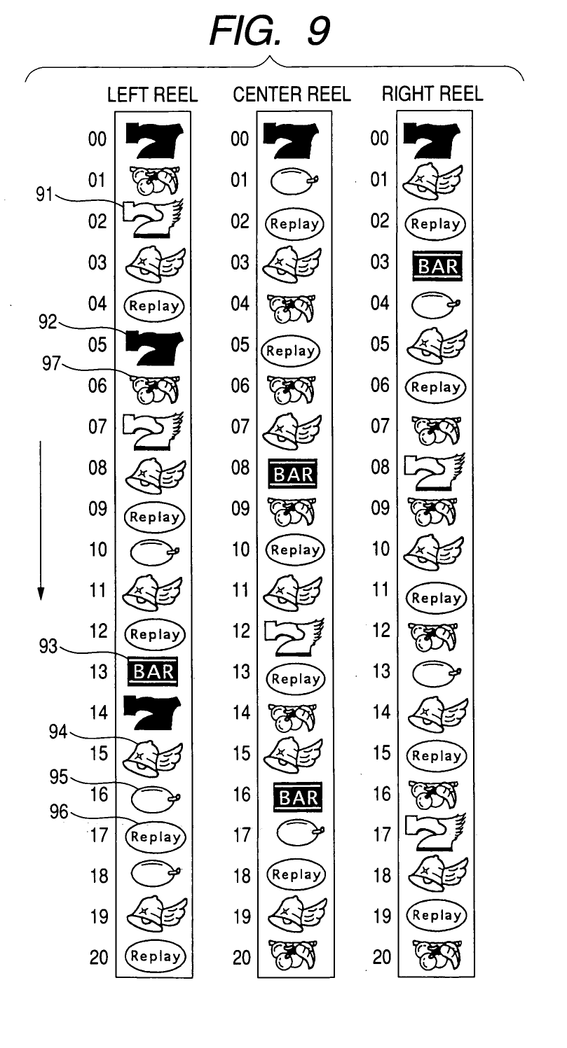

FIG. 8 shows symbol rows each includes 21 symbols represented on each reel 3L, 3C, 3R. The symbols are given code numbers 00 to 20 and are stored in ROM 32 (shown in FIG. 9) described later as a data table.

The symbol rows each includes symbols of “blue 7 (symbol 91),” “red 7 (symbol 92),” “BAR (symbol 93),” “bell (symbol 94),” “plum (symbol 95),” “Replay (symbol 96),” and “cherry (symbol 97)” are represented on the reels 3L, 3C, and 3R. The reels 3L, 3C, and 3R are rotated so that the symbol rows move in the arrow direction in FIG. 8.

FIG. 9 shows the prizes and the numbers of payout medals corresponding to the winning symbol combinations in each gaming state.

The gaming state generally is classified depending on whether or not the internal winning of BB or RB is accepted or whether or not BB or RB operates. The types of prizes having the possibility of accepting internal winning are determined according to a probability lottery table; generally, the probability lottery table is provided for each gaming state.

That is, the types of prizes having the possibility of accepting internal winning become the same for games in the same gaming state. However, BB gaming state contains ordinary gaming state in BB and RB gaming state and contains the state in which the types of prizes having the possibility of accepting internal winning differ.

As shown in FIG. 9, when “blue 7-blue 7-blue 7” or “red 7-red 7-red 7” is placed in a row along the activated line in the ordinary gaming state, a winning game of BB is complete and 15 medals are paid out to the player and the gaming state of the next game enters the BB gaming state.

The RB gaming state occurs when the symbol combination along the activated line is “BAR-BAR-BAR” in the ordinary gaming state or when the symbol combination along the activated line is “Replay-Replay-Replay” in the ordinary gaming state in BB (JAC IN). At this time, 15 medals are paid out to the player.

The RB gaming state is a gaming state in which the player easily gains a prize of paying out 15 medals to the player with completion of the predetermined symbol combination “Replay-Replay-Replay” as the player bets one medal.

The maximum number of games that can be played by the player in one RB gaming state (the number of RB games that can be played) is 12. The number of winning games that can be gained in the RB gaming state (the possible number of winning games of RB) is up to eight. That is, the RB gaming state exits if the number of games reaches 12 or if the number of winning games reaches eight.

The BB gaming state exits when the player performs the third stop operation in a predetermined game. For example, when the player performs the third stop operation in the last game in the third RB gaming state, the BB gaming state exits.

When the symbol combination along the activated line is “Replay-Replay-Replay” in the ordinary gaming state, a winning game of replay is complete. When a winning game of replay is complete, as many medals as the number of inserted medals are automatically inserted, so that the player can play a game without consuming medals.

As symbol combination “bell-bell-bell” is placed in a row along the activated line in the ordinary gaming state or the ordinary gaming state in BB, a winning game of small prize of bell is complete. When the internal winning of small prize of bell is accepted, whether or not the winning game is complete is determined by the table number (described later) and the operation order of the stop buttons 7L, 7C, and 7R by the player.

Specifically, the symbol combination “bell-bell-bell” is placed in a row along the activated line and the winning game of small prize of bell is complete only if the player operates the stop buttons 7L, 7C, and 7R in the operation order of the six operation orders corresponding to the table number. If the player operates the stop buttons 7L, 7C, and 7R in any order other than the operation order corresponding to the table number, the winning game of small prize of bell becomes incomplete.

It is possible to realize completion of winning games of “small prize of cherry,” “small prize of BAR,” and “small prize of plum” in the ordinary gaming state or the ordinary gaming state in BB. The numbers of medals paid out to the player are as shown in the figure.

In the ordinary gaming state, when the internal winning of small prize of bell is accepted, time period (assistance time period or AT) is provided for notifying the player of the operation order for realizing completion of the winning game. When the internal winning of small prize of bell is accepted in the time period, the player can surely realize completion of the winning game.

There are two assistance time period lottery conditions. The first lottery condition is when the internal winning of small prize of plum is accepted and the state is the ordinary gaming state. The second lottery condition is when the internal lottery is a blank in the assistance time period or concealment time period (described later). As either lottery condition is satisfied, assistance time period lottery processing (AT lottery processing) described later is performed.

The assistance time period includes a plurality of successive games, which will be hereinafter referred to as a set. Lottery as to the number of games in one set and the number of sets to be generated is held in the assistance time period lottery processing. The number of sets that can be generated is referred to as the number of sets. If the assistance time period lottery processing is performed in the assistance time period or the concealment time period and prize in the lottery is won, the number of sets is accumulated.

Whether or not the assistance time period is to be generated (actualized) is determined in assistance time period activation processing (AT activation processing) described later. The time period having the possibility that the assistance time period will occur after the lottery condition is satisfied and prize in the AT lottery is won (specifically, the time period in which the value of a number-of-sets counter (described later) is one or more in the ordinary gaming state and which is not the assistance time period) will be hereinafter referred to as the concealment time period. The time period other than the assistance time period or the concealment time period will be hereinafter referred to as the usual time period.

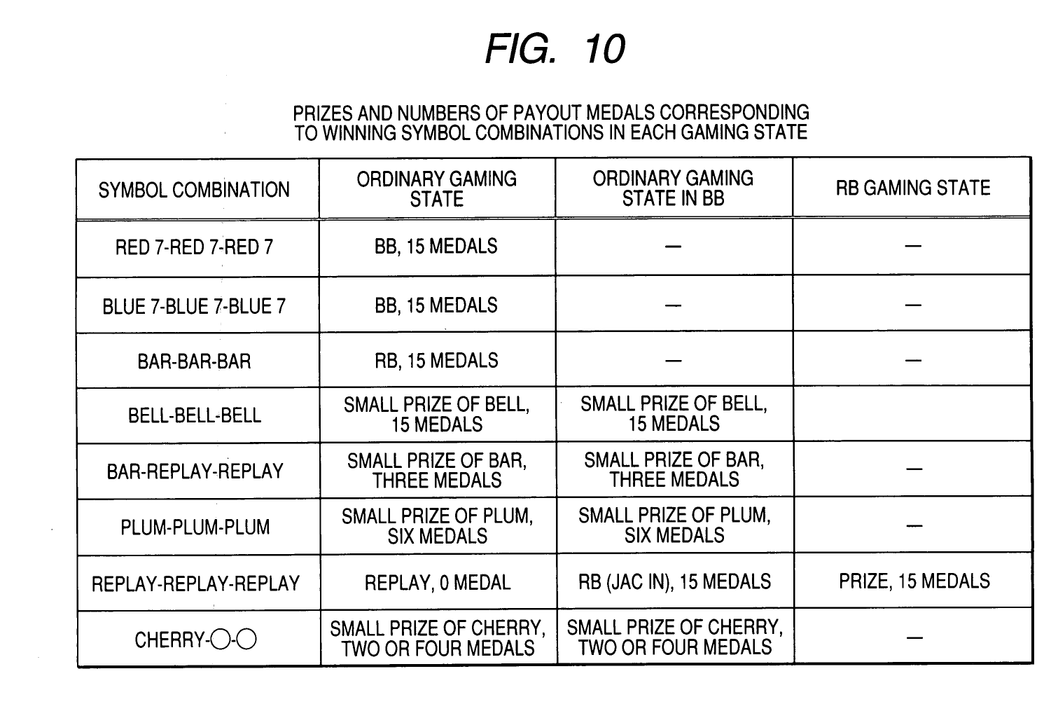

FIG. 10 shows the circuit configuration including the above-mentioned main control circuit 71 (contained in internal lottery means) for controlling the game processing operation of the pinball slot machine, peripherals (actuators) electrically connected to the main control circuit 71, and a sub-control circuit 72 (contained in control means) for controlling the liquid crystal display 5 and the speakers 21L and 21R based on a control command transmitted from the main control circuit 71.

The main control circuit 71 includes the microcomputer 30 placed on the circuit board as the main component and a random number sampling circuit. The microcomputer 30 includes a CPU 31 for performing the control operation in accordance with a preset program, and ROM 32 and RAM 33, both of which are provided as a storage.

Connected to the CPU 31 are a clock pulse generation circuit 34 for generating a reference clock pulse, a frequency divider 35, a random number generator 36 for generating sampled random numbers, and a sampling circuit 37.

For sampling random numbers, random number sampling may be executed in the microcomputer 30, namely, the operation program of the CPU 31. In this case, the random number generator 36 and the sampling circuit 37 can be omitted or can also be left for backup of the random number sampling operation.

The ROM 32 of the microcomputer 30 stores probability lottery tables used to determine random number sampling performed each time the player operates the start lever 6 (start operation), stop control tables for determining the reel stop mode in response to operation of the stop buttons, various control commands to be transmitted to the sub-control circuit 72.

The commands include a standby screen command, and a start command. The commands will be discussed later. The sub-control circuit 72 does not input commands and information to the main control circuit 71 and one-way communications are conducted from the main control circuit 71 to the sub-control circuit 72.

In the circuitry in FIG. 10, the main actuators whose operation is controlled by a control signal from the microcomputer 30 include the various lamps (1-BET lamp 9a, 2-BET lamp 9b, MAX-BET lamp 9c, and WIN lamp 17), the various display units (payout display unit 18, credit display unit 19, and bonus game information display unit 20), a hopper (containing a drive section for paying out medals) 40 as game play value giving means for storing medals and paying out a predetermined number of medals according to an instruction of a hopper drive circuit 41, and stepping motors 49L, 49C, and 49R for rotating the reels 3L, 3C, and 3R.

Further, a motor drive circuit 39 for driving and controlling the stepping motors 49L, 49C, and 49R, a hopper drive circuit 41 for driving and controlling the hopper 40, an individual lamp drive circuit 45 for driving and controlling the various lamps, and an individual display unit drive circuit 48 for driving and controlling the various display units are connected to the output section of the CPU 31 through an I/O port 38. Each of these drive circuits receives a control signal such as a drive command output from the CPU 31 and controls the operation of the corresponding actuator.

The main input signal generation means for generating an input signal required for generating a control command by the microcomputer 30 include a start switch 6S, the 1-BET switch 11, the 2-BET switch 12, the MAX-BET switch 13, the C/P switch 14, a game assistance switch 99, an inserted medal sensor 22S, a reel stop signal circuit 46, a reel position detecting circuit 50, and a payout completion signal circuit 51. These are also connected to the CPU 31 through the I/O port 38.

The start switch 6S detects the player operating the start lever 6. The inserted medal sensor 22S detects a medal inserted to the medal insertion slot 22. The reel stop signal circuit 46 generates a stop signal as the player operates each stop button 7L, 7C, 7R. The reel position detecting circuit 50 receives a pulse signal from a reel rotation sensor and supplies a signal for detecting the position of each reel 3L, 3C, 3R to the CPU 31. The payout completion signal circuit 51 generates a signal for detecting completion of medal payout when the count of a medal detection unit 40S (the number of medals paid out from the hopper 40) reaches the specified number of medals.

In the circuitry in FIG. 10, the random number generator 36 generates random numbers contained in a given numeric value range and the sampling circuit 37 samples one random number at the appropriate timing after the player starts the start lever 6. The CPU 31 determines the internal winning combination based on the random number thus sampled and the probability lottery table stored in the ROM 32. Therefore, the CPU 31 implements winning state determination means for determining the winning state of the game, namely, the internal winning combination by random number lottery.

After rotation of each of the reels 3L, 3C, and 3R is started, the number of drive pulses supplied to each of the stepping motors 49L, 49C, and 49R and the counts are written into a predetermined area of the RAM 33. A reset pulse is obtained every revolution of the reel 3L, 3C, 3R and the reset pulses are input to the CPU 31 through the reel position detecting circuit 50. The drive pulse counts written in the RAM 33 are cleared to “0” according to the reset pulses thus obtained. Accordingly, the counts corresponding to the rotation positions of the reels 3L, 3C, and 3R within the range of one revolution are stored in the RAM 33.

A symbol table is stored in the ROM 32 to relate the rotation positions of the reels 3L, 3C, and 3R and the symbols drawn on the outer peripheral surfaces of the reels to each other. In the symbol table, the code numbers given in sequence every given rotation pitch of each reel 3L, 3C, 3R based on the rotation position where the reset pulse is generated and the symbol codes indicating the symbols provided in one-to-one correspondence with the code numbers are related to each other.

Further, a winning symbol combination table is stored in the ROM 32. The winning symbol combination table lists the symbol combinations of winning games, the numbers of payout medals for the winning games, and the winning game determination codes representing the winning games in association with each other. The winning symbol combination table is referenced at the stop control time of the left reel 3L, the center reel 3C, the right reel 3R and when the winning game is confirmed after all reels are stopped.

If the internal winning is accepted according to lottery processing based on the random number sampling (probability lottery processing), the CPU 31 sends the stop control signal of the reels 3L, 3C, and 3R to the motor drive circuit 39 based on the operation signal sent from the reel stop signal circuit 46 at the timing at which the player operates the stop buttons 7L, 7C, and 7R, and the selected stop control table. The CPU 31 functions as stop control means for performing stop control of the reels 3L, 3C, and 3R.

When the player pushes the stop button 7L, 7C, 7R, the stop control table is referenced and is used to determine the stop position of the reel.

Specifically, when the player pushes the stop button 7L, 7C, 7R, the symbol positioned on the center line 8c on the reel corresponding to the operated stop button (specifically, the symbol whose center is positioned above the center line 8c and is nearest to the position of the center line 8c) is detected, the code number of the symbol (operation position) is collated with the stop control table, and the code number of the symbol to be stopped at the position of the center line 8c (stop position) is determined.

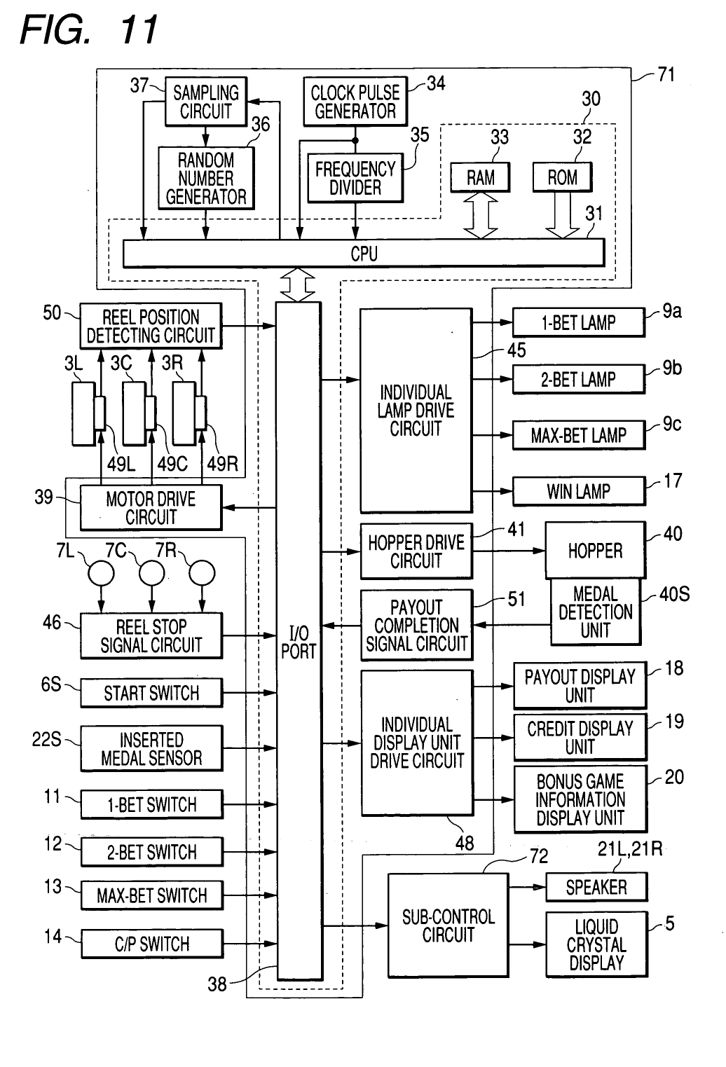

The stop control table used when the internal winning of small prize of bell is accepted will be discussed with reference to FIGS. 11 through 13.

The stop control table lists the stop operation positions and the stop control positions of the reels 3L, 3C, and 3R. The stop operation position represents the code number of the symbol positioned on the center line 8c (specifically, the symbol whose center is positioned above the center line 8c and is nearest to the position of the center line 8c) when the player operates the stop button 7L, 7C, 7R provided corresponding to the reel 3L, 3C, 3R. The stop control position represents the code number of the symbol stopped and displayed at the position of the center line 8c when each of the reels stopped by the player actually stops. In the embodiment, the number of slide frames is four at the maximum. For example, when “cherry” with code number 12 (symbol 97 in FIG. 8) arrives at the position of the center line 8c while the right reel 3R is rotating, if the player operates the stop button 7R, stop control of the right reel 3R can be performed so as to stop and display “blue 7” with code number 8 (symbol 91 in FIG. 8) at the position of the center line 8c.

FIG. 11 shows a winning stop control table. This table is used when stop control of the reels is performed so that “bell-bell-bell” is placed in a row along the activated line and the winning game of small prize of bell is complete after the internal winning of small prize of bell is accepted.

In FIG. 11, the stop control position of the left reel 3L is any of code number “03”, “08”, “11”, “15”, or “19”. In the symbol row shown in FIG. 8, the symbols corresponding to these code numbers are bell (symbol 94).

In FIG. 11, the stop control position of the center reel 3C is any of code number “03”, “07”, “11”, “15”, or “19”. In the symbol row shown in FIG. 8, the symbols corresponding to these code numbers are bell (symbol 94).

In FIG. 11, the stop control position of the right reel 3R is any of code number “01”, “05”, “10”, “14”, or “18”. In the symbol row shown in FIG. 8, the symbols corresponding to these code numbers are bell (symbol 94).

If the winning stop control table shown in FIG. 11 is thus used for stop control of the reels 3L, 3C, and 3R, “bell-bell-bell” is stopped and displayed at the position of the center line 8c, namely, at the centers of the display windows 4L, 4C, and 4R, and the winning game is complete.

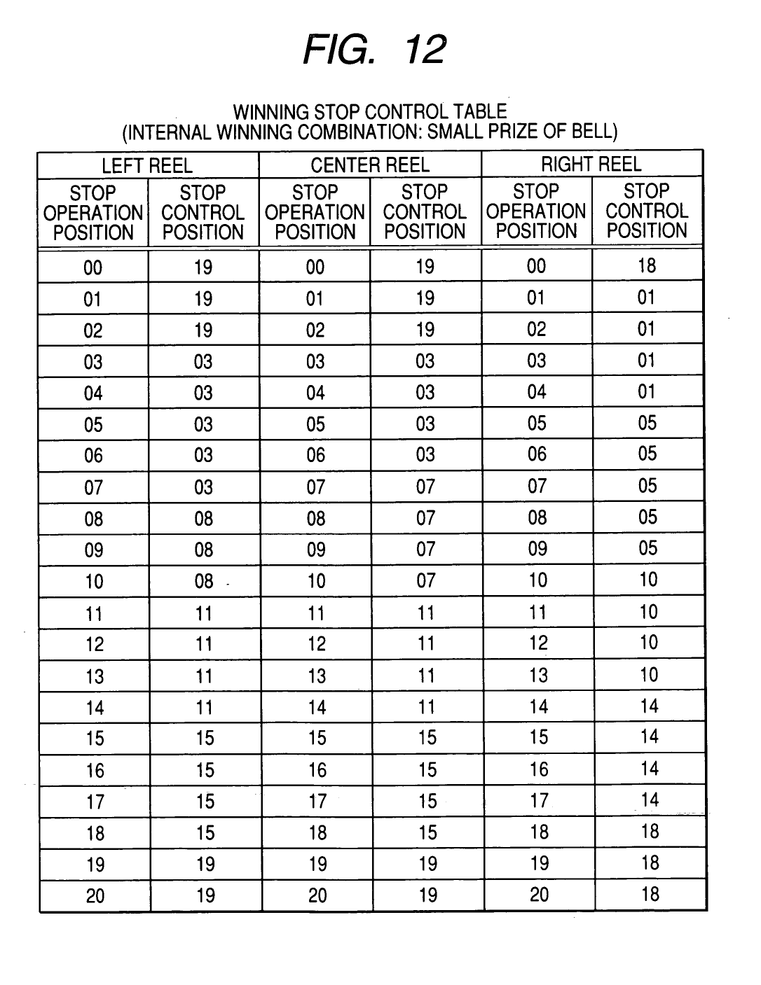

FIG. 12 shows a forward push (left center right), center push (center left right) losing stop control table. This table is used when stop control of the reels is performed so that “bell-bell-bell” is not placed in a row along the activated line (the winning game of small prize of bell is incomplete) after the internal winning of small prize of bell is accepted. The stop control positions corresponding to the stop operation positions of the left reel 3L and the center reel 3C are the same as those shown in FIG. 11.

In FIG. 12, the stop control position of the right reel 3R is any of code number “02”, “06”, “11”, “15”, or “19”. In the symbol row shown in FIG. 8, the symbols corresponding to these code numbers are “Replay (symbol 96).”

If the forward push, center push losing stop control table shown in FIG. 12 is thus used for stop control of the reels 3L, 3C, and 3R, “bell-bell” is stopped and displayed at the centers of the display windows 4L and 4C, and “Replay” is stopped and displayed at the center of the display window 4R and thus the winning game of small prize of bell becomes incomplete.

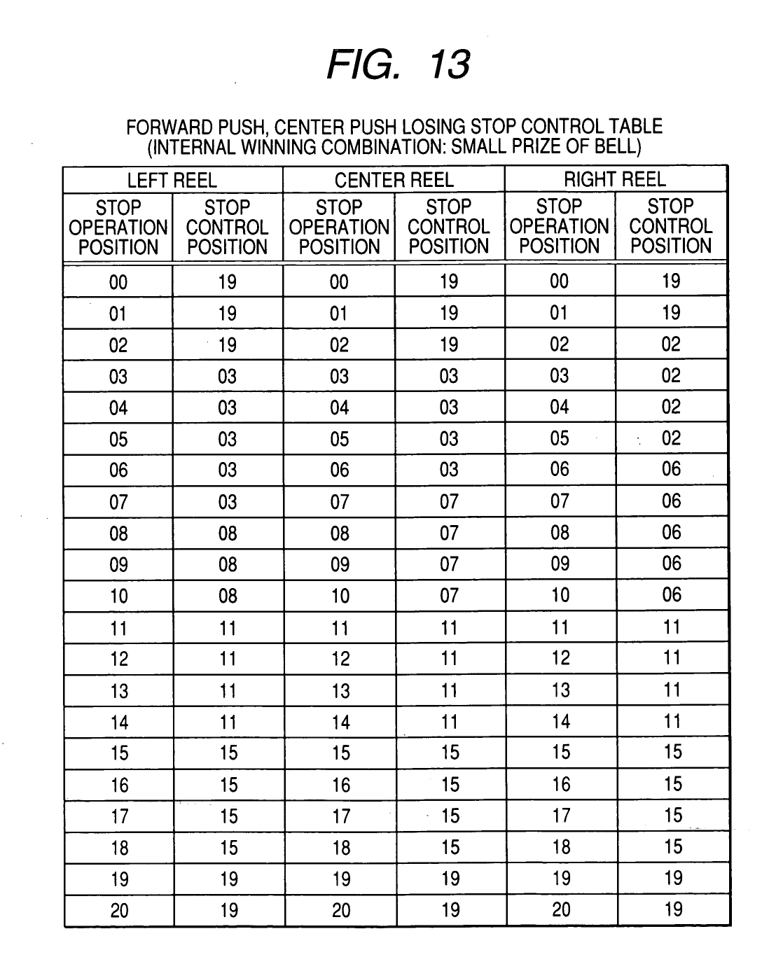

FIG. 13 shows a reverse push (right center left) losing stop control table. This table is used when stop control of the reels is performed so that “bell-bell-bell” is not placed in a row along the activated line (the winning game of small prize of bell is incomplete) after the internal winning of small prize of bell is accepted. The stop control positions corresponding to the stop operation positions of the center reel 3C and the right reel 3R are the same as those shown in FIG. 11.

In FIG. 13, the stop control position of the left reel 3L is any of code number “04”, “09”, “12”, “17”, or “20”. In the symbol row shown in FIG. 8, the symbols corresponding to these code numbers are “Replay (symbol 96).”

If the reverse push losing stop control table shown in FIG. 13 is thus used for stop control of the reels 3L, 3C, and 3R, “Replay” is stopped and displayed at the center of the left display window 4L and “bell-bell” is stopped and displayed at the centers of the display windows 4C and 4R, and thus the winning game of small prize of bell becomes incomplete.

The number of slide frames described above indicates the number of symbols moved until the reel stops after the player operates the stop button and is represented by the absolute value of the difference between the operation position in the stop control table (the code number of the symbol positioned on the center line when the player operates the stop button) and the stop position (the code number of the symbol stopped on the center line when the reel actually stops).

The number of slide frames may be called the number of pulled-in frames.” In the embodiment, the number of slide frames is four at the maximum. For example, when “cherry” with code number 12 (symbol 97 in FIG. 8) arrives at the position of the center line 8c while the right reel 3R is rotating, if the player operates the stop button 7R, stop control of the right reel 3R can be performed so as to stop and display “blue 7” with code number 08 (symbol 91 in FIG. 8) at the position of the center line 8c.

On the other hand, in the stop mode indicating completion of the winning game of internal winning combination, the CPU 31 supplies a payout command signal to the hopper drive circuit 41 for paying out a predetermined number of medals to the player from the hopper 40.

At the time, the medal detection unit 40S counts the number of medals paid out from the hopper 40. When the count reaches the specified number of medals, a medal payout completion signal is input to the CPU 31, which then stops driving the hopper 40 through the hopper drive circuit 41 and terminates the medal payout processing.

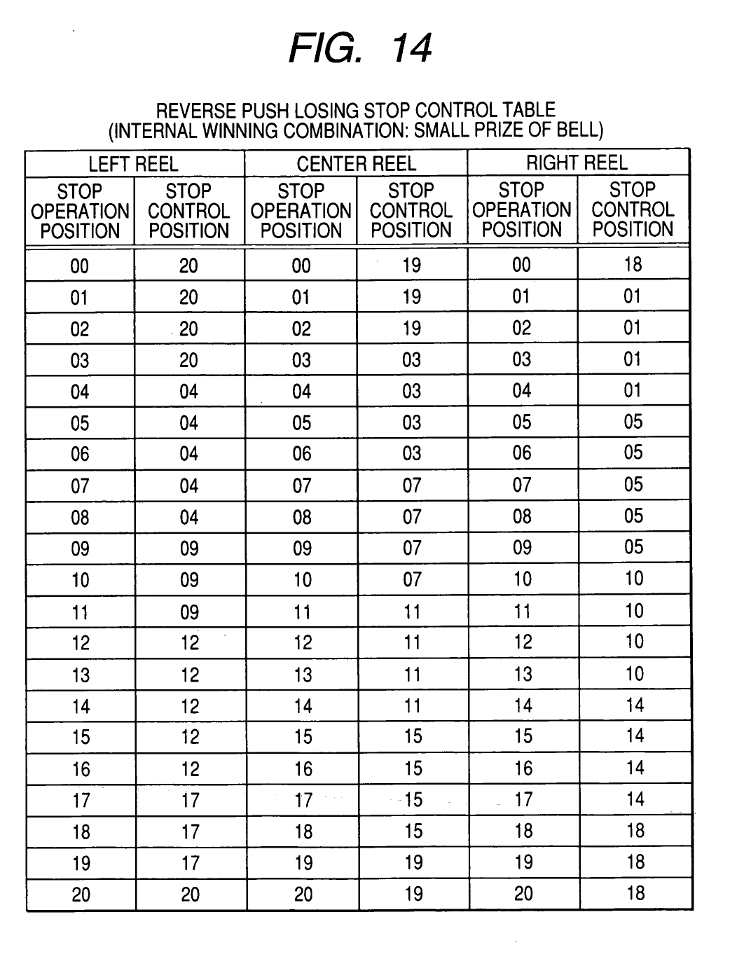

FIG. 14 shows the configuration of the sub-control circuit 72. The sub-control circuit 72 performs display control of the liquid crystal display 5 and output control of sound from the speakers 21L and 21R based on the control commands from the main control circuit 71. The sub-control circuit 72, which is implemented on a separate circuit board from the circuit board implementing the main control circuit 71, includes a microcomputer (sub-microcomputer) 73 as the main component, an image control circuit 81 as display control means of the liquid crystal display 5, a sound source IC 78 for controlling sound output from the speakers 21L and 21R, and a power amplifier 79.

The sub-microcomputer 73 includes a sub-CPU 74 for performing the control operation following a control command transmitted from the main control circuit 71, program ROM 75 as a storage, and work RAM 76. The signal from the main control circuit 71 to the sub-microcomputer 73 is input through an IN port 77, and the signal to the image control circuit 81 is output through an OUT port 80.

The sub-control circuit 72 does not include a clock pulse generation circuit, a frequency divider, a random number generator, or a sampling circuit, but executes random number sampling in an operation program of the sub-CPU 74. Generation of the assistance time period is determined as the random number sampling is executed.

The sub-CPU 74 includes the number-of-AT-sets counter and a number-of-AT-games counter. The number-of-AT-sets counter stores the number of sets. The number-of-AT-games counter stores information concerning the number of games in one assistance time period.

The program ROM 75 stores a control program executed in the sub-CPU 74. The work RAM 76 is used as temporary storage for the sub-CPU 74 to execute the control program.

The image control circuit 81 includes an image control CPU 82, an image control work RAM 83, image control program ROM 84, image ROM 86, video RAM 87, and an image control IC 88. The image control CPU 82 determines the display contents on the liquid crystal display 5 in accordance with an image control program stored in the image control program ROM 84 based on the parameters set in the sub-microcomputer 73. The signal from the sub-CPU 74 is input through an IN port 85.

The image control program ROM 84 stores the image control program involved in display on the liquid crystal display 5 and various selection tables. The image control work RAM 83 is used as temporary storage for the image control CPU 82 to execute the image control program. The image control IC 88 forms an image responsive to the display contents determined by the image control CPU 82 and outputs the image to the liquid crystal display 5. The image ROM 86 stores dot data for forming an image. The video RAM 87 is used as temporary storage for the image control IC 88 to form an image.

On the other hand, the sub-CPU 74 displays an image on the liquid crystal display 5 based on the command signal from the CPU 31.

Specifically, whenever a stop signal is input from the reel stop signal circuit 46 as the player operates the start lever 6 or the stop button 7L, 7C, 7R, the sub-CPU 74 transmits a signal to the image control CPU 82 and displays an image on the display screen 5a of the liquid crystal display 5.

In the embodiment, the CPU 31, the liquid crystal display 5, the sub-CPU 74, and the image control CPU 82 constitute display means as a whole.

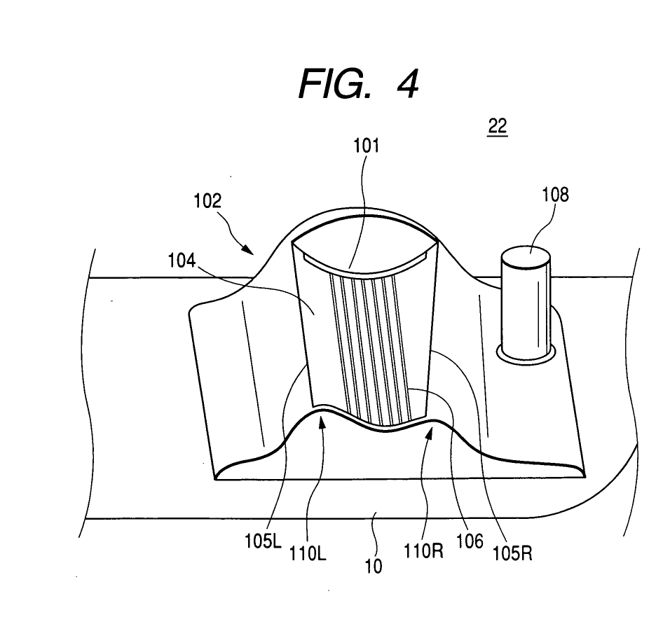

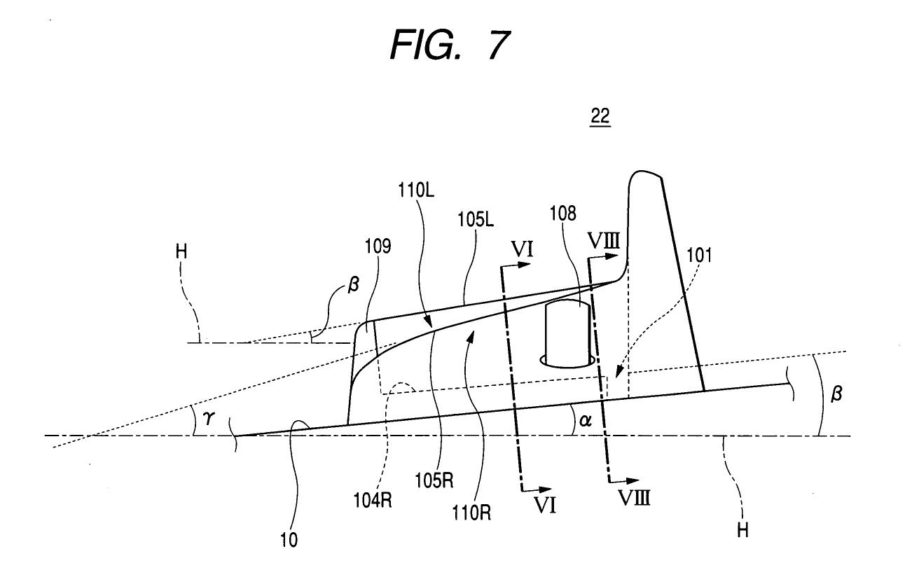

The medal insertion slot 22 will be discussed with reference to FIGS. 4 through 8. As shown in FIG. 4, the medal insertion slot 22 has an opening 101 for the player to insert medals and the player inserts a medal through the opening 101 for playing a game. The opening 101 is formed so that the player can insert a medal with both sides of the medal substantially parallel with the front of the pinball slot machine 1. The medal insertion slot 22 includes a medal guide projection 102 projecting in the forward direction of the pinball slot machine 1 (forward direction from the front of the pinball slot machine 1) for guiding a medal to the opening 101, the medal guide projection 102 being asymmetrical. As shown in FIG. 7, the medal insertion slot 22 is fixed to a frontward projection portion 10 having a predetermined angle (described later) in the forward direction with respect to a horizontal line H, and has a stopper 109. When the player abuts a plurality of medals against an inner peripheral part 104 (described later) before inserting the medal into the opening 101, the stopper 109 is provided for preventing the medal from dropping in the forward direction of the pinball slot machine 1. Referring again to FIG. 4, the medal insertion slot 22 is provided with a return button 108; when the player presses the return button 108, a medal is returned.

The medal guide projection 102 includes the above-mentioned inner peripheral part 104 and a pair of projection parts 110R and 110L.

The inner peripheral part 104, which is a circular arc in cross section, is bent more gently than the outer peripheral surface of the coin and comes in contact with a part of the outer peripheral surface of the medal. The inner peripheral part 104 is formed with a plurality of grooves placed away from each other in the forward width direction (side-to-side direction on the front of the pinball slot machine 1) in the forward direction of the pinball slot machine 1. As the plurality of grooves are formed, when the player slides a plurality of medals along the inner peripheral part 104 into the opening 101, the friction between the outer peripheral surface of each medal and the inner peripheral part 104 is decreased.

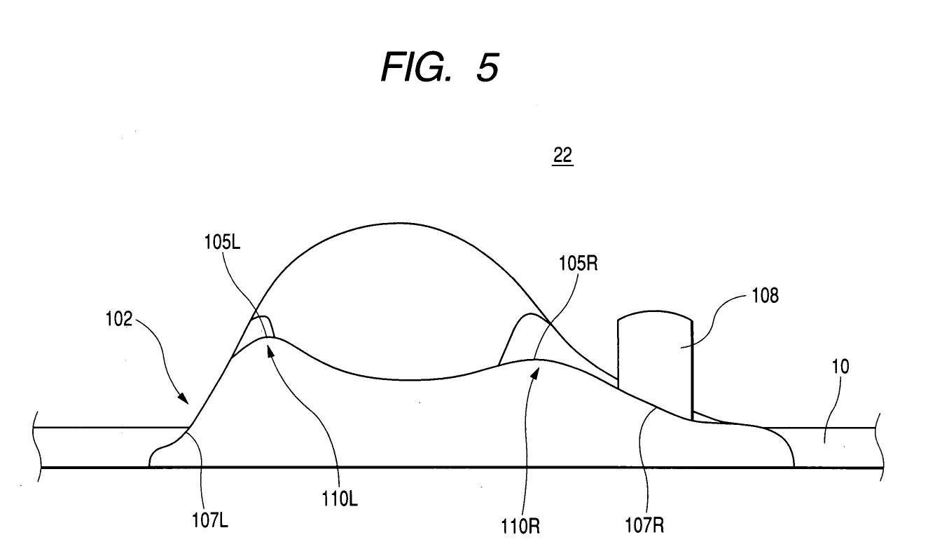

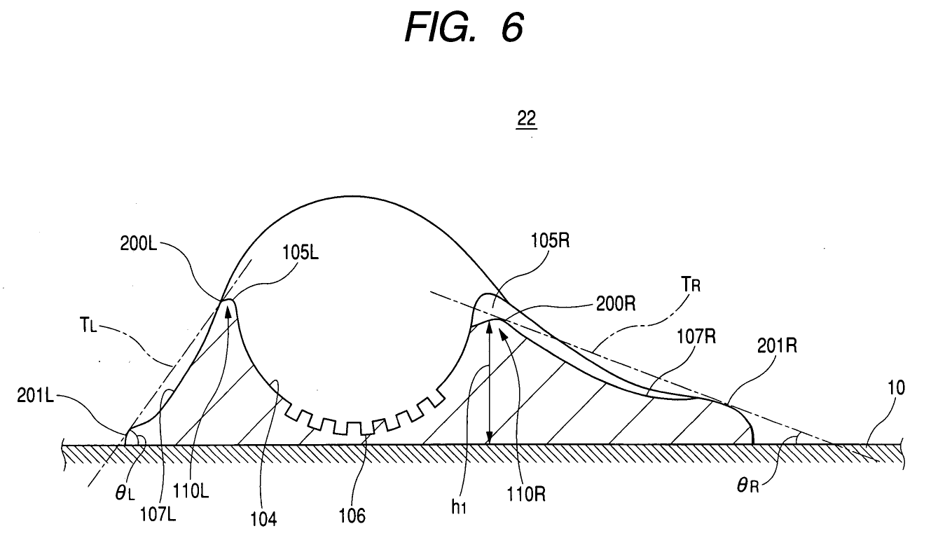

The projection parts 110R and 110L are formed away from each other in the forward width direction of the pinball slot machine 1 on the tops of both ends of the inner peripheral part 104 and project upward from the frontward projection portion 10, as shown in FIGS. 5 and 6. The projection parts 110R and 110L are bent downward along the forward width direction of the pinball slot machine 1; one of the projection parts is bent more gently than the other 110L. In FIG. 7, an angle γ between a ridgeline 105R of one projection part 110R and the horizontal line H differs from an angle β between a ridgeline 105L of the other projection part 110L and the horizontal line H.

The ridgeline 105R of one projection part 110R is bent downward in the forward direction of the pinball slot machine 1, and the curvature grows gradually in the forward direction of the pinball slot machine 1. The curvature refers to the reciprocal of the curvature radius.

The relationship among an angle a between the surface of the frontward projection portion 10 and the horizontal line H, the angle β between the ridgeline 105L of the other projection part 110L and the horizontal line H, and the angle γ between the ridgeline 105R of one projection part 110R and the horizontal line H shown in FIG. 7 will be discussed. The angle α between the surface of the frontward projection portion 10 and the horizontal line H is substantially equal to the angle β between the ridgeline 105L of the other projection part 110L and the horizontal line H. The angle γ between the ridgeline 105R of one projection part 110R and the horizontal line H is larger than the angle α between the surface of the frontward projection portion 10 and the horizontal line H. The angle γ between the ridgeline 105R of one projection part 110R and the horizontal line H is larger than the angle β between the ridgeline 105L of the other projection part 110L and the horizontal line H. The angle between a bottom 104R of the inner peripheral part 104 (see FIG. 6) and the horizontal line H is equal to the angle β between the ridgeline 105L of the other projection part 110L and the horizontal line H. The relationship among the angles is that the angle α nearly equals to the angle β, and the angles α and β are smaller than the angle γ.

The projection parts 110R and 110L have bend sides 107R and 107L, as shown in FIGS. 5 and 6. The side 107R of one projection part 110R has a bend portion with a smaller curvature than that of the side 107L of the other projection part 100L. In FIG. 6, an angle θR between a line TR connecting a top 200R of one projection part θR and a bottom 201R and the surface of the frontward projection portion 10 is smaller than an angle θL between a line TL connecting a top 200L of the other projection part 110L and a bottom 201L and the surface of the frontward projection portion 10. In the embodiment, the surface of the frontward projection portion 10 is parallel with the horizontal line in the forward width direction. Thus, the angle θR is made smaller than the angle θL, so that the player can easily insert a plurality of medals held with the right hand into the nip between the paired projection parts 110R and 110L along the side 107R of one projection part 110R.

As shown in FIG. 8, a height hR of the start point of the ridgeline 105R of one projection part 110R on the side of the opening 101 (see FIG. 4) is the same as a height hL of the start point of the ridgeline 105L of the other projection part 110L on the side of the opening 101 (see FIG. 4). Thus, when the player inserts a plurality of medals held with the right hand into the opening 101 (see FIG. 4), retaining of the medals in the forward width direction can be solidified on the side of the opening 101. Particularly, a height h1 of the ridgeline 105R of the projection part 10R from the frontward projection portion 10 shown in FIG. 6 is lower than a height h2 of the ridgeline 105R of the projection part 110R from the frontward projection portion 10 shown in FIG. 8. According to the structure, the medal is firmly held in the vicinity of the opening 101 (see FIG. 4); on the other hand, the medal is easily inserted on the side of the stopper 109 (see FIG. 7).

In the embodiment, the medal insertion slot 22 is provided on the right of the frontward projection portion 10 as shown in FIG. 1. However, the invention is not limited to the structure shown in FIG. 1. The medal insertion slot 22 may be provided on the left of the frontward projection portion 10. In this case, the relationship between the projection parts 110R and 110L described above may be switched so as to enable the player to easily insert a plurality of medals into the opening 101 with the left hand.

As described above, in the embodiment, the medal insertion slot 22 is formed as described above, so that when the player inserts a plurality of medals held with the right or left hand into the opening 101, failure of inserting medal as the thumb or the forefinger of the player or the medal hits with the projection part 110R can be lessened and the player can easily insert medals into the opening 101.

According to the invention, when the player inserts a plurality of medals held with the right or left hand into the opening, failure of inserting medal as the thumb or the forefinger of the player or the medal hits with the projection part can be lessened and the player can easily insert medals into the opening.

Although only some exemplary embodiments of the invention have been described in detail above, those skilled in the art will readily appreciate that many modifications are possible in the exemplary embodiments without materially departing from the novel teachings and advantages of the invention. Accordingly, all such modifications are intended to be included within the scope of the invention.

This application is related to co-pending U.S. patent applications entitled “GAMING MACHINE” referred to as Attorney Docket No. SHO-0019, “GAMING MACHINE” referred to as Attorney Docket No. SHO-0020, “GAMING MACHINE” referred to as Attorney Docket No. SHO-0021, “GAMING MACHINE” referred to as Attorney Docket No. SHO-0022, “GAMING MACHINE” referred to as Attorney Docket No. SHO-0023, “GAMING MACHINE” referred to as Attorney Docket No. SHO-0024, “GAMING MACHINE” referred to as Attorney Docket No. SHO-0025, “GAMING MACHINE” referred to as Attorney Docket No. SHO-0026, “GAMING MACHINE” referred to as Attorney Docket No. SHO-0027, “GAMING MACHINE” referred to as Attorney Docket No. SHO-0028, “GAMING MACHINE” referred to as Attorney Docket No. SHO-0029, “GAMING MACHINE” referred to as Attorney Docket No. SHO-0030, “GAMING MACHINE” referred to as Attorney Docket No. SHO-0031, “GAMING MACHINE” referred to as Attorney Docket No. SHO-0032, “GAMING MACHINE” referred to as Attorney Docket No. SHO-0033, “GAMING MACHINE” referred to as Attorney Docket No. SHO-0034, “GAMING MACHINE” referred to as Attorney Docket No. SHO-0035, “GAMING MACHINE” referred to as Attorney Docket No. SHO-0036, “GAMING MACHINE” referred to as Attorney Docket No. SHO-0037, “GAMING MACHINE” referred to as Attorney Docket No. SHO-0038, “GAMING MACHINE” referred to as Attorney Docket No. SHO-0039, “GAMING MACHINE” referred to as Attorney Docket No. SHO-0040, “GAMING MACHINE” referred to as Attorney Docket No. SHO-0041, “GAMING MACHINE” referred to as Attorney Docket No. SHO-0042, “GAMING MACHINE” referred to as Attorney Docket No. SHO-0043, “GAMING MACHINE” referred to as Attorney Docket No. SHO-0044, “GAMING MACHINE” referred to as Attorney Docket No. SHO-0045, “GAMING MACHINE” referred to as Attorney Docket No. SHO-0046, “GAMING MACHINE” referred to as Attorney Docket No. SHO-0047, “GAMING MACHINE” referred to as Attorney Docket No. SHO-0048, “GAMING MACHINE” referred to as Attorney Docket No. SHO-0049, “GAMING MACHINE” referred to as Attorney Docket No. SHO-0050, “GAMING MACHINE” referred to as Attorney Docket No. SHO-0051, “GAMING MACHINE” referred to as Attorney Docket No. SHO-0052, “MOTOR STOP CONTROL DEVICE” referred to as Attorney Docket No. SHO-0053, “GAMING MACHINE” referred to as Attorney Docket No. SHO-0054, “GAMING MACHINE” referred to as Attorney Docket No. SHO-0055, “GAMING MACHINE” referred to as Attorney Docket No. SHO-0056, and “GAMING MACHINE” referred to as Attorney Docket No. SHO-0057, respectively, all the applications being filed on Oct. 31, 2003 herewith. The co-pending applications including specifications, drawings, and claims are expressly incorporated herein by reference in their entirety.

What is claimed is:

1. A gaming machine comprising a medal insertion slot having an opening for a player to insert a medal for playing a game,
wherein the medal insertion slot comprises a medal guide projection projecting in a forward direction of the gaming machine and configured to guide the medal to the opening,
wherein the medal guide projection comprises:
an inner peripheral part configured to be in contact with outer peripheral surface of the medal; and
a pair of projection parts disposed away from each other and projecting on top of both ends of the inner peripheral part, and
wherein an angle between a ridgeline of one of the projection parts and a horizontal line is configured to be different from an angle between a ridgeline of the other projection part and the horizontal line.

2. The gaming machine as claimed in claim 1, wherein the angle between the ridgeline of one of the projection parts and the horizontal line is larger than the angle between the ridgeline of the other projection part and the horizontal line.

3. The gaming machine as claimed in claim 1, wherein a height of a start point of the ridgeline of one of the projection parts on a side of the opening is configured to be the same as a height of a start point of the ridgeline of the other projection part on the other projection part on a side of the opening.

4. The gaming machine as claimed in claim 1 further comprising a frontward projection portion configured to fix the medal insertion slot,
wherein an angle between an upper face of the frontward projection portion and the horizontal line is configured to be substantially equal to the angle between the ridgeline of the other projection part and the horizontal line.

5. The gaming machine as claimed in claim 1, wherein an angle between the horizontal line and a line connecting a top of one of the projection parts and a bottom of the one of the projection parts is configured to be smaller than an angle between the horizontal line and a line connecting a top of the other projection part and a bottom of the other projection part.
